(19) United States
(12) Patent Application Publication
(10) Pub. No.: US 2026/0296557 A1
(43) Pub. Date: Oct. 1, 2026

(54) VEHICLE IMPACT ABSORPTION SYSTEMS

(71) Applicants: Hyundai Motor Company, Seoul (KR); Kia Corporation, Seoul (KR); Cleveland-Cliffs Steel Properties Inc., Novi, MI (US)

(72) Inventors: Alex L. Khutorsky, Superior Township, MI (US); Harsha Kusnoorkar, Superior Township, MI (US); Yu-Wei Wang, Novi, MI (US); Miao Yu, Novi, MI (US)

(21) Appl. No.: 19/091,472

(22) Filed: Mar. 26, 2025

(51) Int. Cl. B62D 25/02; B62D 21/15

(52) U.S. Cl. CPC B62D 25/025; B62D 21/157

(57) ABSTRACT

Vehicle reinforcement systems are provided including systems that comprise a plurality of support members configured to absorb energy from an impact on a side of the vehicle. Preferred support members have a tubular configuration and may be composed of distinct steel compositions that differ in one or more properties.

### FIELD

Vehicle reinforcement systems are provided including systems that comprise a plurality of support members configured to absorb energy from an impact on a side of the vehicle. Preferred support members have a tubular configuration and may be composed of distinct steel compositions that differ in one or more.

### BACKGROUND

Electric-powered vehicles (electric vehicles or EV) typically include one or more batteries installed under or within the vehicle floor.

To avoid battery damage from external forces such as occurring during a vehicle collision, efforts have been made to provide certain structural reinforcements, including side sill members proximate to the batteries.

Rocker assemblies have been provided between front and rear wheel wells and below the doors of a vehicle to provide resistance to intrusion into the passenger compartment in side impact collisions. Rocker assemblies also serve to avoid battery damage in electric vehicles. Rocker assemblies may include an outer rocker panel that is joined to a side sill. If the rocker assembly has insufficient structural integrity, it may provide inadequate protection from intrusion in side impact collisions.

Minimizing weight of the structural reinforcements has been a goal, including through use of comparatively lightweight materials of construction such as aluminum and polymer reinforcement components. Electric vehicle side sills have been reinforced with aluminum extrusions to protect the battery during crash tests, including pole side and overlap test. Aluminum has been used due to perceived weight reduction

It would be desirable to have new systems for providing structural integrity to a vehicle. It would be further desirable to have new systems that could provide protection to vehicle battery units during collisions or other impact of the vehicle.

### SUMMARY

We have found that aluminum side sill reinforcements used in electric vehicles suffer from numerous shortcomings, including that aluminum (1) has limited strength, requiring additional material (and added weight) to pass crash tests, (2) is prone to fractures, (3) has limited energy absorption capabilities, (4) cannot use conventional joining methods (i.e., welding), and (5) typically requires additional support brackets.

We now provide new vehicle impact reinforcement that have demonstrated significant structural integrity including in standard impact resistance and energy absorption tests.

In one aspect, the present reinforcement systems include a plurality of support members that are substantially comprised of steel, e.g. where 60, 70, 80, 90, 95, 98, 99 or 100 weight percent of each of the support member consists of one or more steel compositions.

In a further aspect, each of the support members has the same or different tubular configuration.

In a yet further aspect, support members may be composed of steel compositions that differ in one or more properties including composition, mechanical properties such as hardness and ductility, surface coating, heat treatment and/or thickness (gage).

In a further aspect, multiple support members are arranged together based on material strength or other characteristics.

More particularly, in one embodiment, a reinforcement system for a vehicle is provided that comprises a plurality of support members configured to absorb energy from an impact on a side of the vehicle, wherein at least two or more of the support members are substantially composed of steel. In aspects, at least two of the support members are adjacent members, for example where walls of each support member are abutting or otherwise in connect or where the adjacent support members are affixed such as by a weld or adhesive.

In one preferred aspect, the system comprises:
1) a first outer zone that comprises at least one outer support member that is composed of a steel composition;
2) a second intermediate zone that comprises at least one middle support member that is composed of steel composition; and
3) a third inner zone that comprises at least one inner support member that is composed of a steel composition.

In these preferred systems, the support members of each zone may be formed from different steels with differing properties such as hardness and ductility. Thus, in certain aspects, the system comprises 1) a first outer zone that comprises at least one steel outer zone support member; 2) a second intermediate zone that comprises at least one steel intermediate zone support member; and 3) a third inner zone that comprises at least one steel inner zone support member, and the steel compositions of at least two of the outer zone support member, intermediate zone support member and inner zone support member are different. In aspects, the steel compositions of each of the outer zone support member, intermediate zone support member and inner zone support member are different.

In further aspects, in certain preferred reinforcement systems, 1) the first outer zone may comprise an outer support member that is composed of a steel that has a high strength and preferably good ductility; 2) the second zone may comprise a support member that is composed of steel with a high strength and suitably ductility less than the first zone outer support member steel; and 3) the third inner zone may comprise an inner support member that is composed of steel with strength about equal to or greater than the outer support member steel.

In a preferred arrangement for an electric vehicle, the third inner zone may in a position closest to the position of the vehicle batteries, and the first outer zone would be the most distal from the vehicle batteries and the zone that would first absorb a side impact (e.g. collision) of the vehicle.

In a particularly preferred aspect, the first zone comprises two vertically arranged tubular members that are each composed of steel that has a high strength and preferably good ductility; and the third inner zone comprises a single tubular support member.

In further aspects, vehicles including electric vehicles are provided that comprise a lateral energy absorption system as disclosed herein, for example a system comprising: a plurality of support members configured to absorb energy from an impact on a side of the vehicle; wherein at least two of the support members are substantially composed of steel.

Preferably, at least two of the support members have a tubular configuration. Preferably at least three of the support members are substantially composed of steel. Preferably, multiple support members are substantially composed of steel and each of the multiple support members is composed of steel that differs in strength and/or ductility with respect to other support members.

In certain aspects, the steel of the reinforcement elements may be a coated or treated steel, for example, galvanized steel or galvannealed coated steel. In other aspects, the steel may be an untreated (not coated) steel.

Unless otherwise indicated, references herein to steel are inclusive of alloys of those metals. Thus, for example, references herein to steel is inclusive of various steels and steel alloys including any of stainless steel, high-strength steel, high-carbon steel, low-carbon steel, and/or galvanized steel and other coated steels.

As referred to herein, tensile stress (TS) and elongation (EL) can be measured using a commercially available tensile tester and according to the ISO standard ISO 6892-1, published in October 2009.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system. In aspects, a vehicle may comprise a pure electric vehicle.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

### BRIEF DESCRIPTION OF THE DRAWINGS

The accompanying drawings, which are incorporated in and form a part of the Detailed Description, illustrate various non-limiting and non-exhaustive embodiments of the subject matter and, together with the Detailed Description, serve to explain principles of the subject matter discussed below.

FIG. 1 shows a vehicle with a reinforcement system and associated side sill.

FIG. 2 depicts a schematic of a preferred reinforcement system with multiple zones.

FIG. 3 depicts a schematic of a further preferred reinforcement system with multiple zones

FIG. 4 depicts a schematic of a further preferred reinforcement system with multiple zones positioned within a vehicle side sill.

FIGS. 5, 6 and 7 are images of steel tubular elements configured for use in differing zones of a present reinforcement assembly.

FIGS. 8 and 9 each show schematic cross-sectional views of arranged tubular reinforcement elements.

FIGS. 10A and 10B show cut-away views of a reinforcement system positioned within a vehicle side sill.

FIG. 11 is an above view of a preferred reinforcement assembly.

FIG. 12 shows side views of varying reinforcement elements with varying cross-sectional shapes and configurations.

### DETAILED DESCRIPTION

As discussed above, we now provide new lateral impact systems or lateral energy absorption systems that have demonstrated significant structural integrity, including meeting or exceeding crash performance targets.

In aspects, the elements may be tubular with varying cross-sectional dimensions and shapes. In preferred aspects, the reinforcement elements can fit within a standard cavity created by side sill OTR and INR panels of current vehicles including electric vehicles.

Preferred systems include multiple functional zones or areas with differing materials of construction to provide tailored properties. In particular aspects, distinct elements such as steel tubular elements can be constructed of different steel compositions to provide desired hardness, ductility, or other properties to thereby efficiently and effectively absorb impact to a vehicle, including to efficiently manage impact energy and control intrusions during a crash event. In aspects, preferred systems may have 2, 3 or 4 or more multiple functional zones or areas.

Preferred systems may include a grouped arrangement of multiple reinforcement elements 2, 3, 4, 5, 6 or more elements grouped or associated together (e.g. nested together or preferably affixed to one or more adjacent element such as by weld or adhesive) and preferably providing multiple functional zones or areas as discussed above.

In certain preferred systems having multiple functional zones, a first zone (Zone A or Energy Absorption Zone) is most distal to an electric vehicle battery pack area and is the first area to be contacted by an impacting object (e.g. stationary object such as a pole or tree or moving object such as another vehicle).

In such preferred systems, adjacent to the first zone is a second zone (Zone B which may be a Rotation Controlling Zone) and can be configured to mitigate rotation of the entire reinforcement assembly and prevent bending of a Battery Cross Member. This second zone (Zone B) also can provide additional backing support to the adjacent first zone (first zone being most distal to the vehicle interior and battery area in the case of an electric vehicle). Additionally, Zone B can suitably serve as an attachment platform for example for brackets or other attachment devices connecting the tubular reinforcement to a Side Sill (BIW).

In such preferred systems, adjacent or abutting the second zone may be a third zone (Zone C or (Intrusion Restriction Zone)) which can limit deformation and minimize intrusion rates toward a proximate electrical battery. The third zone also preferably may be positioned within the second zone, for example in a central region of the second zone or mid-height of the second zone.

In certain preferred systems, for the distal first zone (Zone A), steel elements (e.g. steel tubular elements) may be preferably employed, suitably formed from high strength steel such as a steel tensile strength of at least 900, 1000, 1100 or 1200 MPa, with a tensile strength of 1100 or 1200 to 1500 MPa being preferred in at least certain aspects. Additionally, in certain aspects, for the first zone (Zone A), the high strength steel has sufficient ductility to deform without fracture and absorb energy, for example an elongation value (EL) of at least 5.5%, 6%, 7%, 8%, 9%, 10%, or 11%, with an EL of 6 to 11% being preferred in at least certain aspects. Exemplary preferred steel compositions for use to form reinforcement elements for this first zone include 1200DP/1200MP or Boron Hardenable QHS1500 with 1.4 to 1.6 mm thickness. In certain preferred aspects, for this first zone (Zone A), multiple (e.g. two) two symmetrical steel tubular elements may be employed preferably with square or rectangular cross-sectional shape.

In certain preferred aspects, reinforcement steel tubular elements for this first zone (Zone A) may be tapered toward the impact direction. Such tapering may reduce part weight. In certain preferred aspects, the first zone (Zone A) may constitute 25 to 50 percent of the total cross section of the reinforcement system, or in certain aspects 30 to 40 percent of the total cross section of the composite reinforcement system, for example the system that includes each of Zones A, B and C.

In certain preferred systems, for the second zone (Zone B), steel elements (e.g. steel tubular elements) may be preferably employed, suitably formed from high or ultrahigh strength steel such as a steel tensile strength of at least 1000, 1100, 1200, 1300, 1400, 1500, 1600, 1700, 1800 or 1900 MPa, including 1500 to 1900 MPa or 1700 to 1900 MPa. Exemplary preferred steel compositions for use to form reinforcement elements for this second zone include 1200DP (SPFC 1180 Y), Boron Hardenable QHS1500, or Martensitic Steel 1500 with 0.8 to 1.2 mm thickness. In certain preferred aspects, for this second zone, one or two, and preferably one, elongated steel tubular elements may be employed preferably with a Height/Width ratio of 0.7 to 0.9. As discussed above, the second zone tubular element may be configured wherein the third zone reinforcement elements may be positioned within or inside the second zone.

In certain preferred systems, for the third zone (Zone C), steel elements (e.g. steel tubular elements) may be preferably employed, suitably formed from high or ultrahigh strength steel such as a steel tensile strength of at least 1000, 1100, 1200, 1300, 1400, 1500, 1600, 1700, 1800 or 1900 MPa, including 1500 to 1900 MPa or 1700 to 1900 MPa. Exemplary preferred steel compositions for use to form reinforcement elements for this third zone include Boron Hardenable QHS1700-1900 or Martensitic Steel 1700-1900 with 1.5 to 1.7 mm thickness.

In certain preferred aspects, reinforcement steel tubular elements for the third zone (Zone C) may be tapered toward the battery position in a vehicle.

In certain aspects, a reinforcement system is preferred that includes at least four steel tubular elements. Systems that include a total of four steel tubular elements are preferred in at least certain aspects.

It also has been found that a ratio between relatively short tubes (tubes toward impact) and longer tubes (backing) can be important. In certain aspects, preferred is where the ratio of length (y direction) of short tubes or length of longer tubes (i.e. L_{Short}/L_{Long}) is 0.40 to 0.60 or more preferably a ration of L_{Short}/L_{Long} 0.45 to 0.55.

It also has been found selection of the height (Z direction) of the tubular reinforcement elements can more effectively mitigate rotation of an associated side sill and prevent or inhibit bending of an associated battery cross member.

The height of the longer tubular elements also can establish positions where one or more brackets or other attachment members may be located to join the reinforcement system to an associated side sill. For certain preferred reinforcement systems, a maximum height of 50 to 80 mm may be preferred or a height of up to or at least 50, 60, 70, or 80 mm.

Further preferred are reinforcement systems where one or more tubular elements of one functional zone are positioned within one or more element of a distinct functional zone. Such configurations can provide notable advantages, including weight reduction of the total reinforcement system, for example where the wall thickness of the small inner or encased tubular elements is increased and the wall thickness of a larger encasing larger outer tubular element is reduced.

Also preferred in certain aspects are reinforcement systems that include at least two, and in certain aspects a total of two, parallel longer tubular elements.

In certain aspects, it also can be preferred that one or more tubular reinforcement elements are tapered along at least a portion of the element length. Such tapering can provide effective weight reduction of the overall reinforcement system.

The preset reinforcement systems can be readily produced. For example, in one production protocol, in a first step, rounded tub elements may be processed on a high frequency tube mill; in a second step, roll forming of round tub is performed to achieve required profile of a tubular element; in a third step, individual tubular elements are assembled for example by welding (continuous or intermittent) such as with laser or GMA process. Assembly of the formed elements can be divided in two sub-assemblies and two levels welds. Assembly of one or more tubular elements within an element of a distinct functional zone suitably may be achieved with a seam (suitably laser). Assembly of one or more tubular elements within an element of a distinct functional zone also may include adhesive bonding of the elements. The forming of the assembling joints between tubular elements suitably may be made through a continuous or intermittent process. Additional brackets or other attachments devices can be readily affixed to the formed reinforcement assembly, including through use of nut-welds and without the cutting of mounting holes.

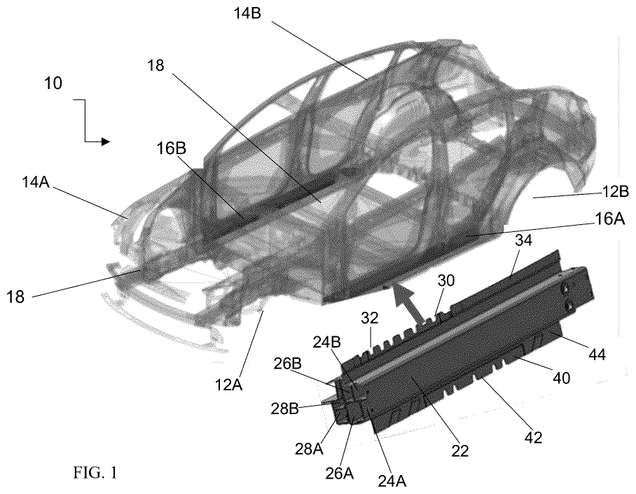

Referring now to the drawings, FIG. 1 depicts vehicle 10 with wheel wells 12A, 12B, 14A, 14B and side sills 16A, 16B encasing vehicle battery area 18. Exploded side sill view 22 of 16A depicts incorporated reinforcement system with multiple steel tubular elements 24A, 24B, 26A, 26B, 28A and 28B. Side sill 22 includes mating flanges 30, 32, 34, 40, 42, 44 that connect the side sill within vehicle 10. Elements 24A, 24B, 26A, 26B, 28A and 28B may be formed from differing steel compositions and form distinct functional zones as discussed above, for example elements 24A and 24B may be formed from a relatively high strength steel (e.g. a tensile strength of at least 1000 or 1200 MPa) with reasonable ductility (e.g. EL of at least 6) to effectively absorb a side impact to the vehicle. Elements 28A and 28B may be formed from a high strength steel (e.g. a tensile strength of at least 1000 or 1200 MPa) to ensure protection of batteries within area 18.

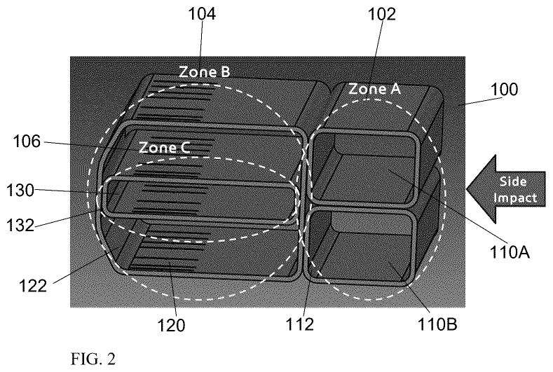

FIG. 2 shows a preferred reinforcement system 100 that includes multiple distinct zones 102 (Zone A), 104 (Zone B) and 106 (Zone C). Zone 102 (Zone A) includes steel tubular elements 110A and 110B and would be first contact of system 100 to a side impact to the vehicle. Zone 104 (Zone B) includes at least one tubular element 120 with outer wall 22. Wall 112 of zone 102 (Zone A) suitably abuts the wall of zone 104 (Zone B) tubular element as depicted in FIG. 2. Zone 106 (Zone C) that includes tubular element 130 positioned within zone 104 with element 130 outer wall positioned within walls 122 of element. As discussed above, elements 110A and 110B, 120 and 130 may be constructed of different steel compositions with differing properties such as differing hardness and ductility.

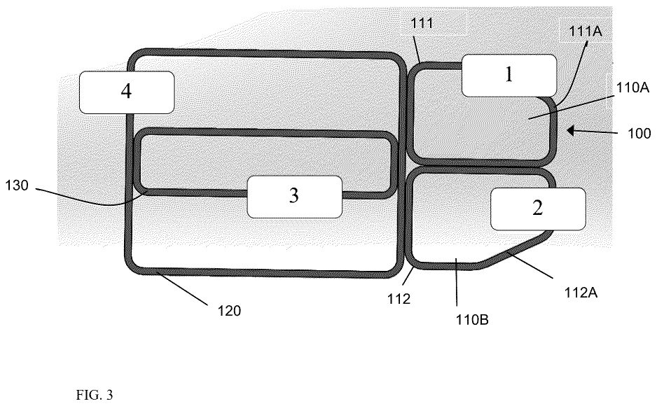

FIG. 3 depicts a preferred reinforcement system 70 of a similar configuration as discussed above for FIG. 2. System 100 includes a total of four tubular elements 11, 112, 120 and 140. Zone A includes the stacked tubular elements 111 and 112 that includes sidewalls 111A and 112A that are tapered in direction of a side impact to the assembly 100.Zone B includes tubular elements 130 that is positioned within Zone C tubular element 120.

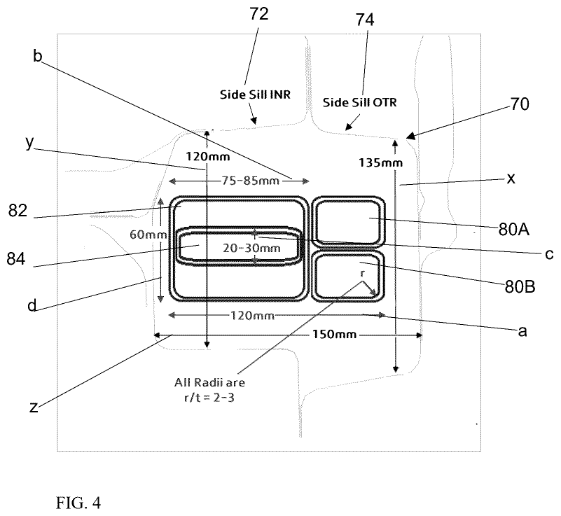

FIG. 4 depicts a preferred reinforcement system 70 of a similar configuration as discussed above for FIGS. 2 and 3. System 70 is nested with side sill INR 72 and side sill OTR 74. The first zone (Zone A) tubular elements 80A and 80B abut the third zone (Zone C) tubular element 82. That element 82 encases second zone (Zone B) element 84. Exemplary suitable and preferred dimensions are depicted in FIG. 3 including side sill nesting area heights x (suitably e.g. from about 100 to 150 mm such as the depicted 135 mm) and y (suitably e.g. from about 100 to 150 mm such as the depicted 120 mm) and width z (suitably e.g. up to or about 100 to 120 mm such as the depicted 150 mm); height d of the assembly 70 (suitably e.g. up to or about 40 to 80, 100, 120, 500 m, 180 or 200 mm such as the depicted 60 mm); width z of the assembly 70 (suitably e.g. up to or about 80, 100, 120, 500 m, 180 or 200 mm such as the depicted 120 mm); and width y of the element 82 (suitably e.g. up to or about 50, 60, 70, 80, 90, 120, 140 or 150 mm such as the depicted 75 to 85 mm).

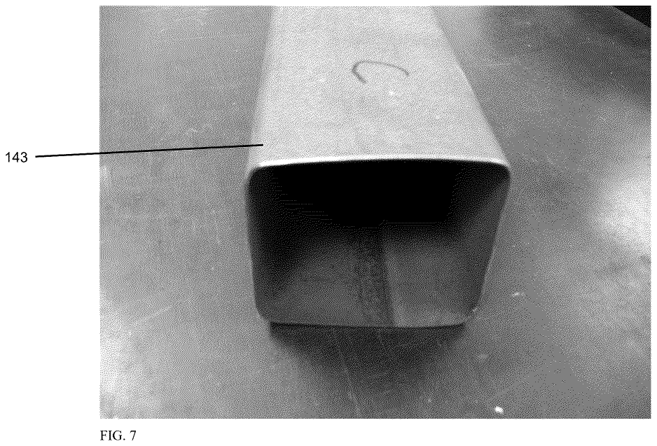

FIGS. 5, 6 and 7 are images (photographs) are preferred tubular elements

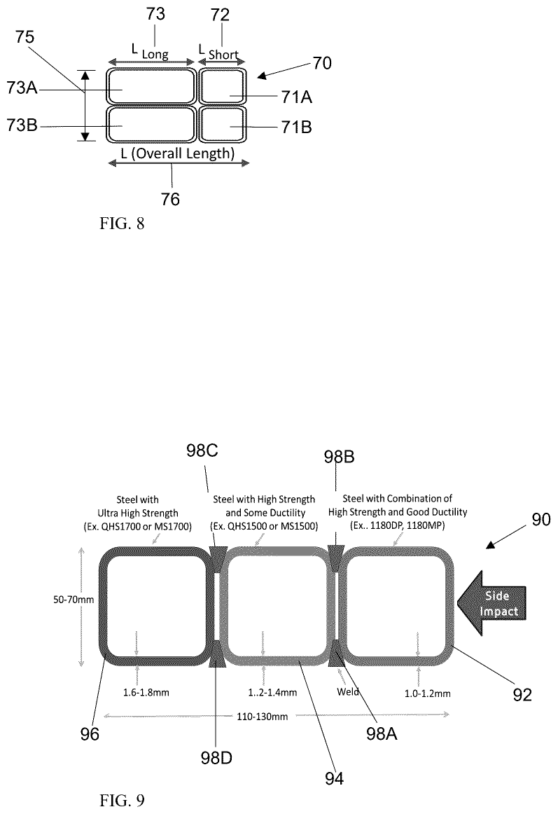

FIG. 8 depicts another preferred reinforcement system 70 that depicts tubular reinforcement elements 71A and 71B that have a relatively shorter length L 72 and tubular reinforcement elements 73A and 73B have a relatively longer length L 75. The system length L 76 is the composite of length 72 and 75.

FIG. 9 depicts schematically a preferred reinforcement assembly 90 with steel tubular elements 92, 94 and 96. Exemplary preferred element wall thicknesses and materials of construction are set forth in FIG. 9. The elements 92, 94 and 96 are suitably affixed via welds 98A, 98B, 98C and 98D. Each of the elements 92, 94 and 96 may provide a zone of differing functionality of the overall reinforcement assembly as discussed above.

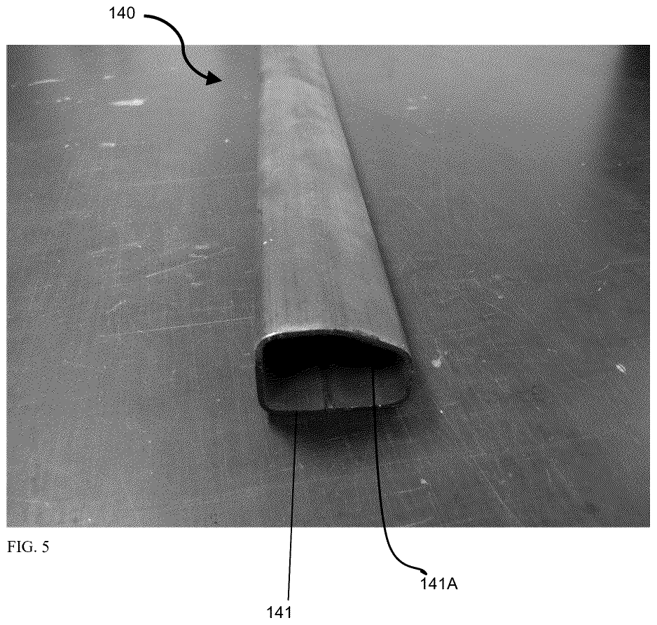

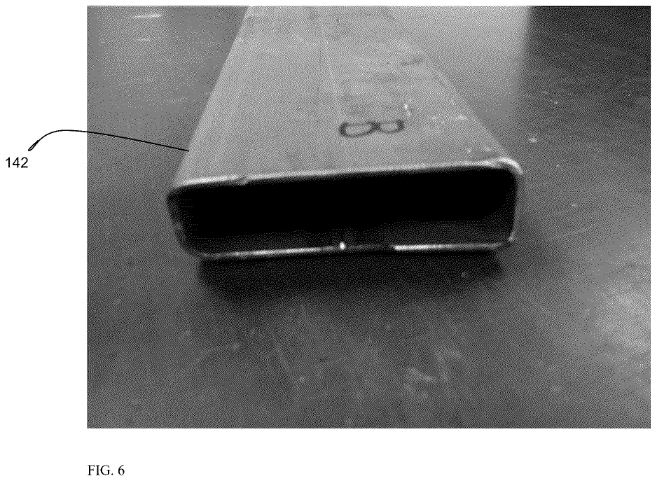

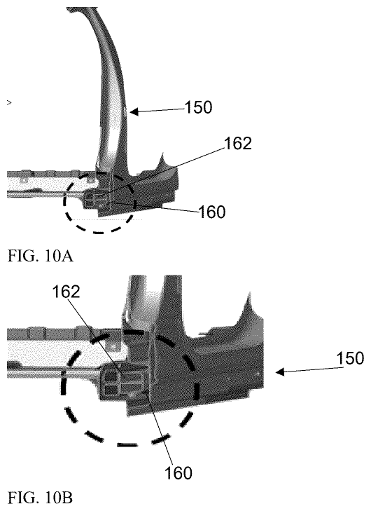

FIGS. 10A and 6B show a vehicle side sill 150 encasing a reinforcement assembly 160 with multiple steel tubular elements 162.

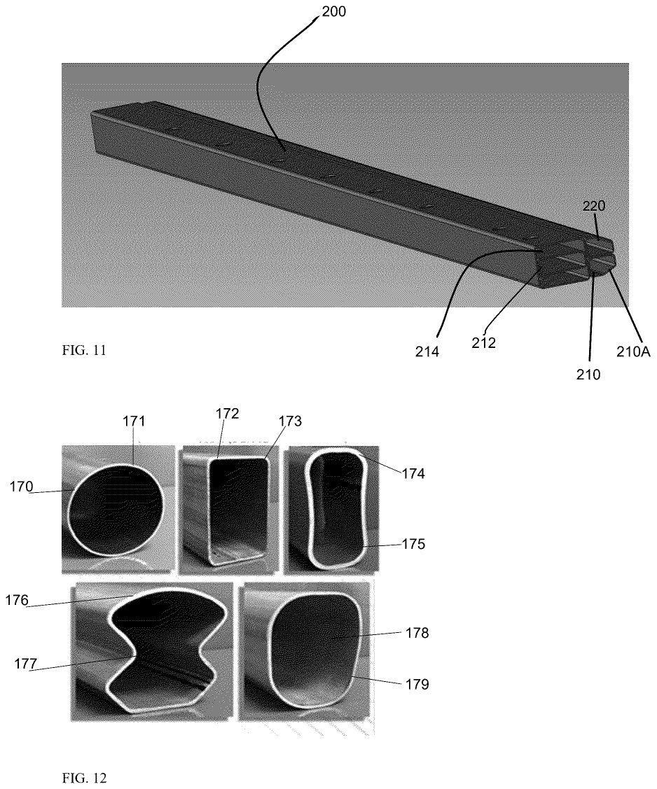

FIG. 11 shows reinforcement assembly 200 with Zone A steel tubular members 210 and 220 that include walls 210A tapered toward a direction of impact to the assembly as positioned within a vehicle. Zone C tubular element 212 is encased within Zone B tubular element 214.

FIG. 12 shows steel tubular elements 170, 172, 174, 176, and 178 with differing cross-sectional shapes, including a rounded (e.g. ellipsoidal, circular) cross-sectional shaped element as exemplified by substantially circular wall 171 and oval walls 175 and 179; a tubular element that includes corners (e.g. square, rectangular, triangular, pentagonal, hexagonal and the like) as exemplified by rectangular element wall 173; an element wall with varying cross-sectional dimension such as waved element wall 177 and tapered wall 175.

The following non-limiting examples are illustrative.
Example 1: Preparation of lateral energy absorption system

Tubular elements are prepared of the configuration and materials shown in FIG. 4. The tubular elements are formed by roll forming of the specified steel sheets. The separate formed steel tubes are assembled by continuous or intermitted welding process (laser, GMA or GTA).

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

What is claimed is:

1. A reinforcement system for a vehicle, comprising:
a plurality of support members configured to absorb energy from an impact on a side of the vehicle; and
wherein at least two of the support members are substantially composed of steel.

2. The system of claim 1, wherein at least two of the support members have a tubular configuration.

3. The system of claim 1 wherein at least three of the support members are substantially composed of steel.

4. The system of claim 1 wherein multiple support members are substantially composed of steel and each of the multiple support members is composed of steel that differs in composition, strength, ductility and/or hardness with respect to other support members.

5. The system of claim 1 wherein the system comprises 1) a first outer zone that comprises at least one steel outer zone support member; 2) a second intermediate zone that comprises at least one steel intermediate zone support member; and 3) a third inner zone that comprises at least one steel inner zone support member, and the steel compositions of at least two of the outer zone support member, intermediate zone support member and inner zone support member are different.

6. The system of claim 5 wherein the outer zone support member has a tensile strength of at least 1000 MPa, and elongation value of at least 6%; the intermediate zone support member has a tensile strength of at least 900 MPa, and an elongation value of at least 5%; and the inner zone support member has a tensile strength of at least 1400 MPa.

7. The system of claim 5 wherein the outer support member has a tensile strength of at least 1200 MPa; the middle support member has a tensile strength of at least 1000 MPa; and the inner support member has a tensile strength of at least 1500 MPa.

8. The system of claim 5 wherein the first zone comprises two vertically arranged tubular members that are each composed of steel that has a high strength and good ductility; and the third inner zone comprises a single tubular support member.

9. The system of claim 1 wherein at least two support members are affixed to at least one adjacent support member.

10. The system of claim 1 further comprising a vehicle battery.

11. A vehicle, comprising:
a reinforcement system comprising:
a plurality of support members configured to absorb energy from an impact on a side of the vehicle;
wherein at least two of the support members are substantially composed of steel.

12. The vehicle of claim 11 wherein at least two of the support members have a tubular configuration.

13. The vehicle of claim 11 wherein at least three of the support members are substantially composed of steel.

14. The vehicle of claim 11 wherein multiple support members are substantially composed of steel and each of the multiple support members is composed of steel that differs in strength and/or ductility with respect to other support members.

15. The vehicle of claim 11 wherein the system comprises 11 wherein the system comprises 1) a first outer zone that comprises at least one steel outer zone support member; 2) a second intermediate zone that comprises at least one steel intermediate zone support member; and 3) a third inner zone that comprises at least one steel inner zone support member, and the steel compositions of at least two of the outer zone support member, intermediate zone support member and inner zone support member are different.

16. The vehicle of claim 15 wherein the outer zone support member has a tensile strength of at least 1000 MPa, and elongation value of at least 6%; the intermediate zone support member has a tensile strength of at least 900 MPa, and an elongation value of at least 5%; and the inner zone support member has a tensile strength of at least 1400 MPa.

17. The vehicle of claim 15 wherein the outer support member has a tensile strength of at least 1200 MPa; the middle support member has a tensile strength of at least 1000 MPa; and the inner support member has a tensile strength of at least 1500 MPa.

18. The vehicle of claim 15 wherein the first zone comprises two vertically arranged tubular members that are each composed of steel that has a high strength and good ductility; and the third inner zone comprises a single tubular support member.

19. The vehicle of claim 11 wherein each support member is affixed to at least one adjacent support member.

20. The vehicle of claim 11 wherein the vehicle is an electric vehicle.
